(19) United States
(12) Patent Application Publication
(10) Pub. No.: US 2026/0312825 A1
(43) Pub. Date: Oct. 8, 2026

(54) CROSS-CLUSTER AUTHENTICATION USING AN EPHEMERAL TOKEN

(71) Applicant: Dell Products, L.P., Round Rock, TX (US)

(72) Inventors: Sandesh Shivaram, Kraków (PL); Ananthakrishnan Balakrishnan, Edison, NJ (US); Seema Tahaliyani, Southborough, MA (US); Yuanyuan Zhang, Newark, CA (US)

(21) Appl. No.: 19/169,480

(22) Filed: Apr. 3, 2025

(51) Int. Cl. H04L 9/32

(52) U.S. Cl. CPC H04L 9/3263

(57) ABSTRACT

Architectures and techniques are described that can facilitate cross-cluster authentication without requiring user credential synchronization or continual delegation of credential checks. Each computing cluster can have a dedicated certificate authority (CA), which issues ephemeral tokens to authenticated users. When a user from a first cluster seeks access at a second cluster, the second cluster receives the user's ephemeral token, retrieves and validates the signing certificate from the user's home cluster CA, and authenticates the user based on a verified digital signature rather than relying on the user's home cluster for each request. This solution can avoid replicating credentials across clusters, can reduce cross-cluster communication, and can permit independent management of local authentication domains. By employing short-lived, cryptographically signed tokens, the disclosed matter can provide strong security guarantees and reduces latency, ensuring a robust and scalable mechanism for authenticating users across multiple clustered environments.

### BACKGROUND

Storage or data service providers typically organize services by clusters. Most users typically log into to services via an associated home cluster interface, where a local certificate authority (CA) device will authenticate all user access in response to input of the user credentials such as login name and password. Thus, today, storage or data service providers generally deploy an independent authentication domain for each cluster such that a user from one cluster cannot be natively authenticated at a different cluster.

### BRIEF DESCRIPTION OF THE DRAWINGS

Numerous aspects, embodiments, objects, and advantages of the present embodiments will be apparent upon consideration of the following detailed description, taken in conjunction with the accompanying drawings, in which like reference characters refer to like parts throughout, and in which:

FIG. 1 shows a schematic block diagram illustrating an example storage or data services platform or system that authenticates users on a per-cluster basis in accordance with certain embodiments of this disclosure;

FIG. 2 shows a schematic block diagram illustrating an approach to cross-cluster authentication relating to delegation of the authentication in accordance with certain embodiments of this disclosure;

FIG. 3 shows a schematic block diagram illustrating an approach to cross-cluster authentication relating to synchronizing or adding credentials to the guest cluster in accordance with certain embodiments of this disclosure;

FIG. 4 depicts a schematic block diagram illustrating an example cluster that can generate an ephemeral token that can be used for cross-cluster authentication without relying on delegation or adding/synching credentials in accordance with certain embodiments of this disclosure;

FIG. 5A depicts a schematic block diagram illustrating an establishment of trust by exchanging the cluster CA certificates in accordance with certain embodiments of this disclosure;

FIG. 5B depicts a schematic block diagram illustrating certain contents of an example session token in accordance with certain embodiments of this disclosure;

FIG. 6 a schematic block diagram illustrating an example device that can use an ephemeral token to provide cross-cluster authentication without relying on credential synchronization or access to the guest cluster in accordance with certain embodiments of this disclosure;

FIG. 7 depicts a call flow diagram illustrating certain sequences of events or interactions relating to creation or use of an ephemeral token for cross-cluster authentication in accordance with certain embodiments of this disclosure. ;

FIG. 8 illustrates an example method that can use an ephemeral token to provide cross-cluster authentication without relying on credential synchronization or access to the guest cluster in accordance with certain embodiments of this disclosure;

FIG. 9 illustrates an example method that can provide additional aspects or elements relating to using an ephemeral token to provide cross-cluster authentication without relying on credential synchronization or access to the guest cluster in accordance with certain embodiments of this disclosure;

FIG. 10 illustrates a block diagram of an example distributed file storage system that employs tiered cloud storage in accordance with certain embodiments of this disclosure; and

FIG. 11 illustrates an example block diagram of a computer operable to execute certain embodiments of this disclosure.

### DETAILED DESCRIPTION

### Overview

The disclosed subject matter is now described with reference to the drawings, wherein like reference numerals are used to refer to like elements throughout. In the following description, for purposes of explanation, numerous specific details are set forth in order to provide a thorough understanding of the disclosed subject matter. It may be evident, however, that the disclosed subject matter may be practiced without these specific details. In other instances, well-known structures and devices are shown in block diagram form in order to facilitate describing the disclosed subject matter.

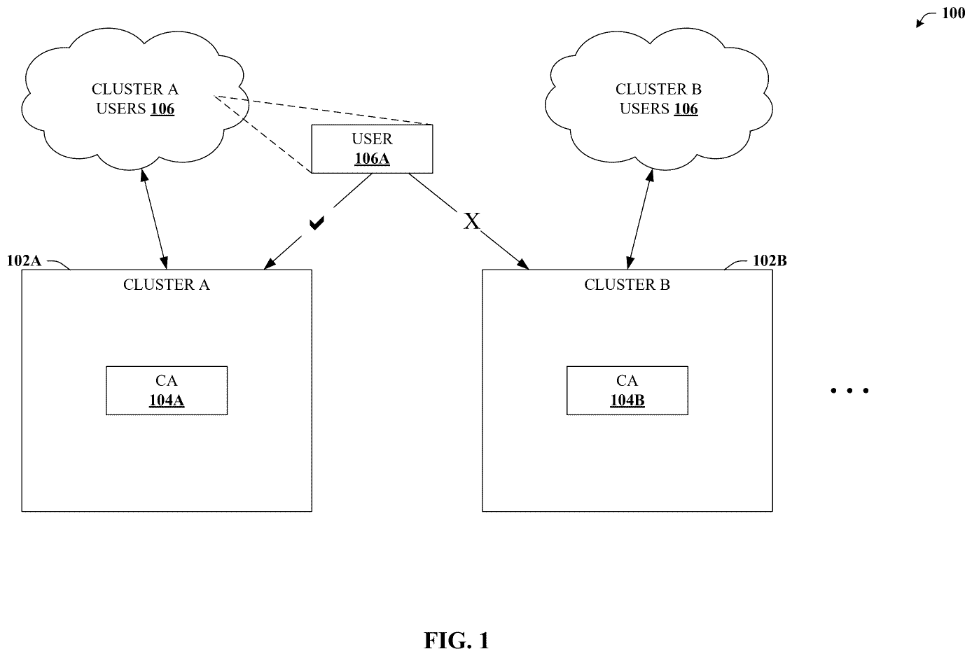

To provide additional context, consider FIG. 1. FIG. 1 shows a schematic block diagram illustrating an example storage or data services platform or system 100 that authenticates users on a per-cluster basis in accordance with certain embodiments of this disclosure. As depicted, the system can be organized according to many separate clusters 102, which are illustrated here as cluster 102A and cluster 102B, noting that any suitable number of clusters 102 may exist. While the same data may be synchronized between the various clusters 102, authentication of users is typically handled independently on a per-cluster basis. Hence, each cluster can have its own certificate authority (CA) 104, illustrated as CA 104A and CA 104B. This CA 104 can be any suitable device or service such as a hardware device that operates to provide a CA service for the associated cluster 102.

Each cluster 102 can have an independent authentication domain (e.g., an associated CA 104) to which users 106 are added. Generally, among all users 106 of system 100, most will log into the system via their home cluster 102. As such, users 106 having a home cluster of cluster 102A will generally log into cluster 102A and be authenticated by CA 104A, while users 106 having a home cluster of cluster 102B will generally log into cluster 102B and be authenticated by CA 104B. A given user 106A (e.g., from the subset of users 106 having cluster 102A as the home cluster) can be readily authenticated by CA 104A, but cannot be readily authenticated by cluster 102B. Such is hereinafter referred to as cross-cluster authentication, where a given user (e.g., 106A) attempts to log into the system via a cluster 102 that is not his or her home cluster.

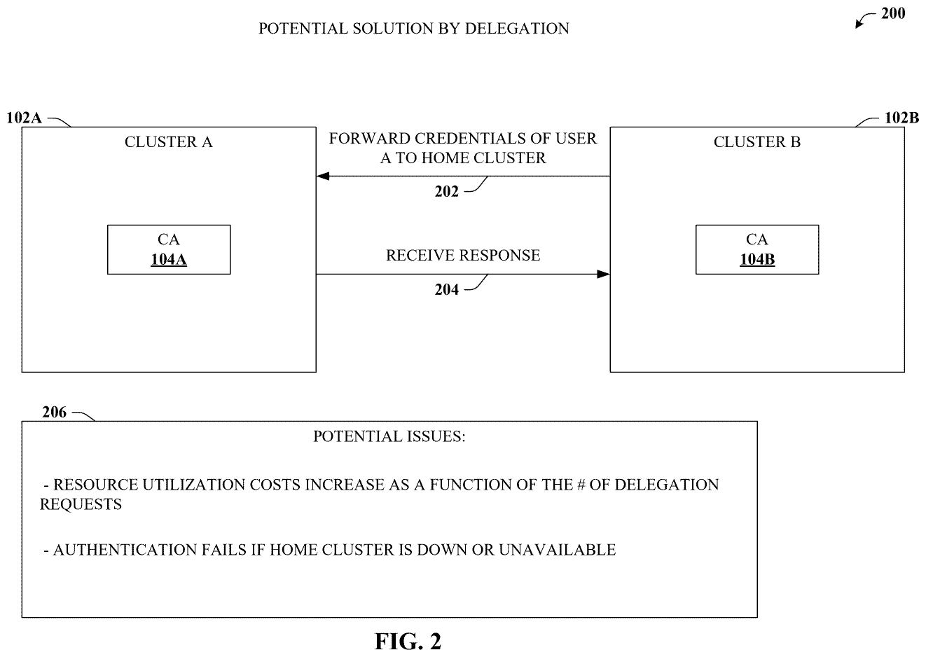

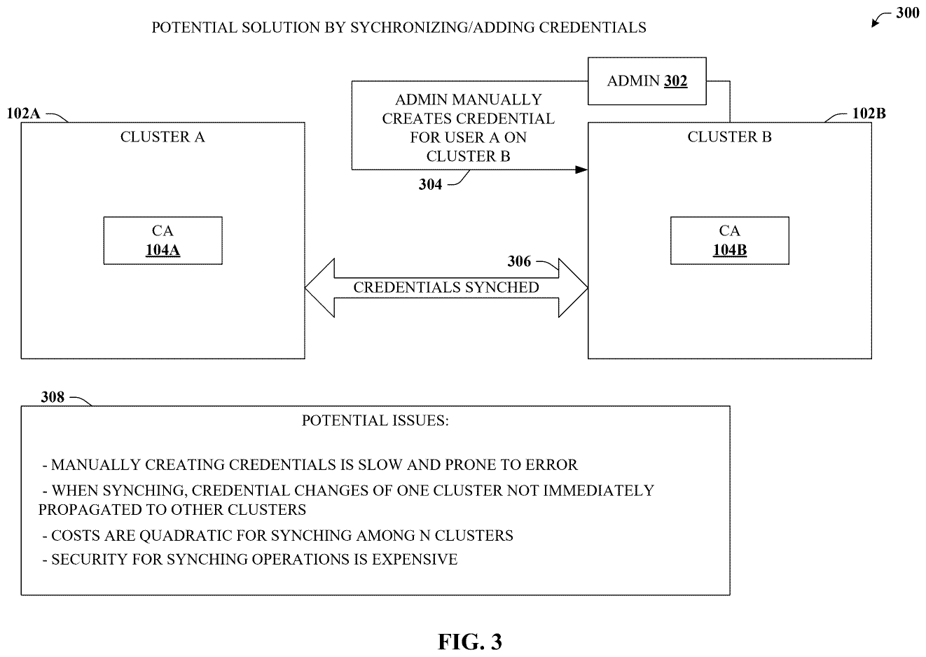

Thus, generally speaking, local users from one cluster 102 cannot authenticate with other clusters 102. There are situations when a customer would want a local user from one cluster to be able to log into other clusters. For example, customers of the storage or data services platform sometimes deploy isolated clusters for various reasons. Enabling cross-cluster authentication can be challenging for various reasons, which is further detailed in connection with FIGS. 2 and 3 relating to various approaches or potential solutions to those challenges.

FIG. 2 shows a schematic block diagram 200 illustrating an approach to cross-cluster authentication relating to delegation of the authentication in accordance with certain embodiments of this disclosure. For example, when user 106A attempts to log into cluster 102B, cluster 102B can simply forward the credentials input by user 106A to that particular user's home cluster, in this case cluster 102A. Such is illustrated at reference numeral 202. At reference numeral 204, a response as to the authentication can be received by cluster 102B. Hence, authentication can be handled by the user's home cluster just as it would occur otherwise for a given user logging into his or her own home cluster.

However, while this approach can be effective, there are certain potential issues or drawbacks, which are indicated at reference numeral 206. For example, resource utilization costs increase as a function of the number of delegation requests. Hence, while this solution can be reliable, resource utilization costs can grow significantly over time in many use cases. Furthermore, as can be appreciated, authentication cannot be performed and will therefore fail if the home cluster (e.g., cluster 102A) is down or otherwise unavailable or unreachable by the guest cluster (e.g., cluster 102B).

FIG. 3 shows a schematic block diagram 300 illustrating an approach to cross-cluster authentication relating to synchronizing or adding credentials to the guest cluster in accordance with certain embodiments of this disclosure. For example, as shown at reference numeral 304, an admin 302 for the cluster 102B can manually create credentials for user 104A on cluster 102B. Such newly added credentials can be used by user 104A. There are potential issues or drawbacks with this strategy as well as shown at reference numeral 308. For example, manually creating credentials can be tedious and slow and can also be prone to error. This approach is not applicable at scale and is generally only useful for a small number of requests.

Thus, alternatively, wholesale credential synchronization can be performed, as illustrated at reference numeral 306. In that case, substantially any user on a given cluster can be readily authenticated to any other cluster in which the synchronization operation is performed. Yet again, this approach has certain issues or drawbacks, as indicated at reference numeral 308. For example, when synching between clusters, credential changes (e.g., newly added, recently revoked, . . . ) at one cluster are not immediately available at another cluster, but rather will not be updated until the associated synching operation occurs. As a result certain security issues can arise and authentication procedures can be delayed.

In addition, when synching between only two or a small number of clusters 102 may not otherwise be significant, the costs associated with synching among N clusters increases according to a quadratic function. Moreover, security for the synchronizing operations can significantly add to the expense. Further still, it is to be appreciated that wholesale credential synching does not readily provide (e.g., without increasing costs potentially significantly) granular control of cross-cluster authentication. For example, suppose it would be preferred that only a subset of users 106 of cluster 102A should be permitted to log into another cluster or that the subset changes depending on the guest cluster. Such cannot be controlled by wholesale credential synching, at least not without significant oversight by administrators.

In consideration of FIGS. 1-3, it can be appreciated that in large or distributed computing environments, organizations often deploy multiple isolated clusters, each with its own local authentication domain and distinct user credential store. However, users frequently need to access resources or services across more than one cluster, relying on some mechanism for cross-cluster authentication. As indicated, one approach is to delegate authentication to the home cluster by forwarding user login requests from the guest cluster. This method can create high latency and availability concerns because each request must travel to the home cluster, and can introduce performance issues as traffic increases. Further, if the home cluster is offline or the network link is disrupted, the guest cluster cannot verify user credentials.

Another approach, in which administrators manually add credentials to the guest cluster, requires creation of separate user accounts on each target environment. This burdens administrators with time-consuming setup tasks and risks error when updates do not propagate consistently across multiple clusters. Synchronizing credentials among clusters can also be problematic as well. Replication or credential synchronization often carries significant overhead: it can be complex to manage, consume large amounts of network bandwidth, and expose credentials to security risks should any one cluster be compromised. These approaches demonstrate why a solution that avoids per-request delegation calls, eliminates the burden of local credential creation or broad-based synchronization, and still allows users to present trusted credentials outside their home cluster would be of significant value to organizations operating numerous clusters.

To these and other related ends, the disclosed subject matter is directed to mechanisms or techniques that allow a user from one cluster to authenticate seamlessly in another cluster without sharing or replicating local credentials. Each cluster can serve as its own mini certificate authority by generating a cluster CA certificate and an associated signing certificate. Administrators can then exchange CA certificates across clusters only once, creating a loose trust federation that does not require a centralized identity provider.

When a user wishes to access another cluster (e.g., that is not that user's home cluster), that user first obtains an ephemeral token (e.g., from the home cluster's token service), which signs the token with the home cluster's private key. The token includes details such as the user ID and an expiration time. The guest cluster verifies the signature against its locally stored copy of the home cluster's CA certificate. This process eliminates the need to replicate credentials or call the home cluster on each request, while ensuring that only trusted tokens are accepted. Furthermore, extensive granular control can be afforded to the cross-cluster authentication in a simplified manner that does not exist with wholesale credential synchronization.

### Example Systems

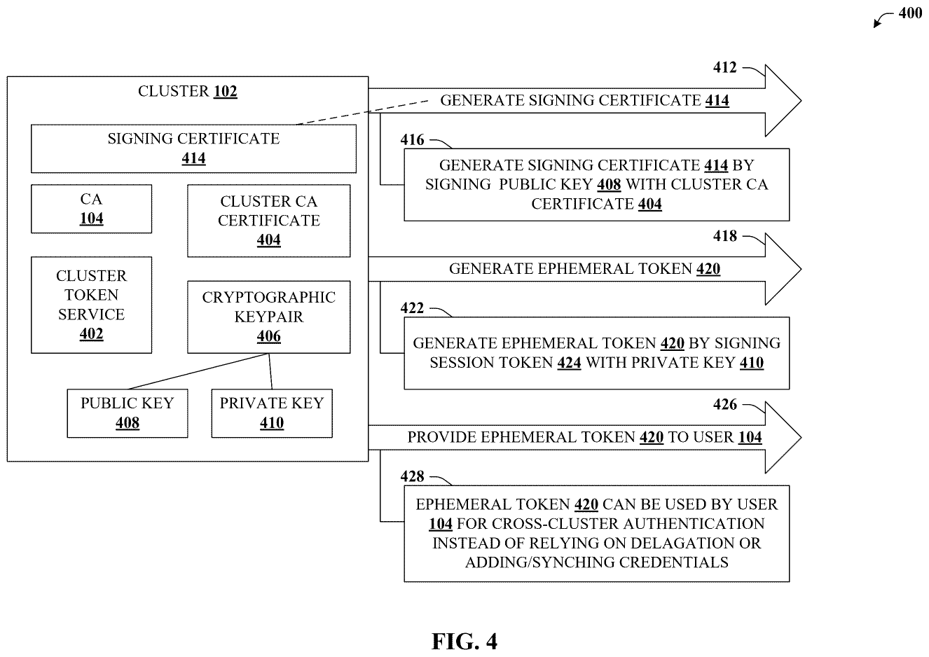

With reference now to FIG. 4, a schematic block diagram is depicted illustrating an example cluster 102 that can generate an ephemeral token that can be used for cross-cluster authentication without relying on delegation or adding/synching credentials in accordance with certain embodiments of this disclosure.

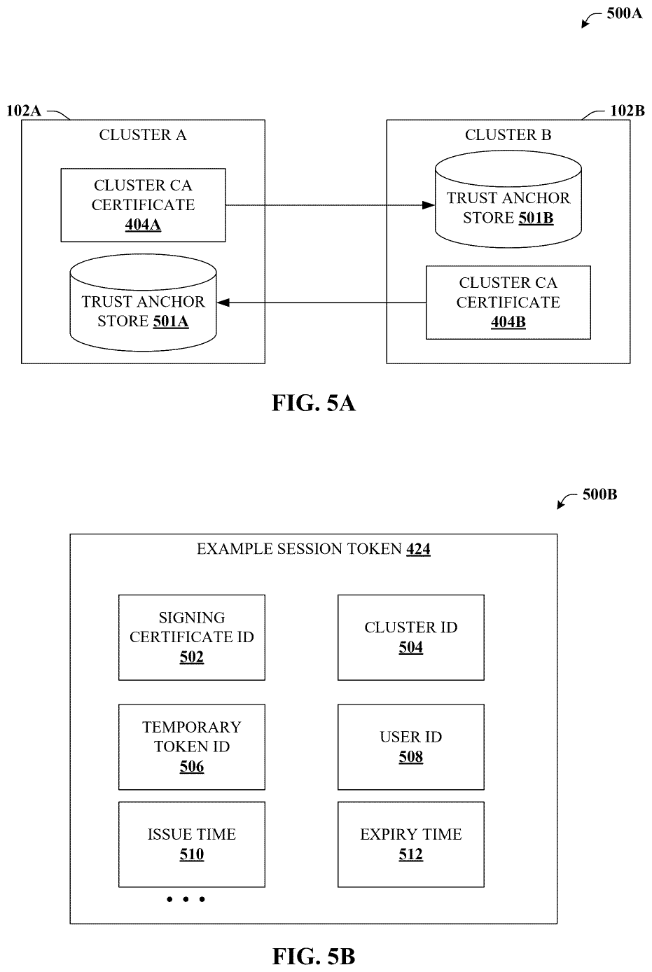

In some embodiments, cluster 102 can operate as its own certificate authority (CA) 104 for establishing trust relationships and can include a cluster token service 402 for issuing tokens used in cross-cluster authentication. Cluster 102 can rely on the associated CA 104 to serve as the source of trust for issuing and signing subordinate certificates. These subordinate certificates may, for example, be used to identify specific services running in the cluster or to sign ephemeral tokens. Cluster CA certificate 404 can represent the public-facing certificate for CA 104, containing identifying information such as the cluster's name or ID and the public key of the CA. Administrators in other clusters can import this cluster CA certificate 404 into their local trust anchors, thereby granting them the ability to verify certificates and signatures originating from cluster 102, which is further detailed in connection with FIG. 5A.

While still referring to FIG. 4, but turning now as well to FIG. 5A, a schematic block diagram 500A is depicted illustrating an establishment of trust by exchanging cluster CA certificates 404 in accordance with certain embodiments of this disclosure. For example, trust can be established between multiple different clusters via cluster CA certificates 404. In that regard, cluster 102A can share cluster CA certificate 404A with cluster 102B. Cluster 102B can store this to a trust anchor store 501, in this case trust anchor store 501B.

Likewise, cluster 102B can share cluster CA certificate 404B with cluster 102A, which can be stored to trust anchor store 501A. It can be appreciated that a trust federation can be established in this manner. Each cluster 102 (e.g., an associated administrator) can control which other clusters 102 to trust by downloading or otherwise obtaining an associated cluster CA certificate 404. As will be further detailed below, cluster CA certificates 404 stored in a given trust anchor store, as well as the establishment of trust, can be used by the associated cluster 102 in connection with ephemeral tokens.

The cluster token service 402 manages the lifecycle of ephemeral tokens that users from cluster 102 will present to other clusters in the federation. This service works closely with a cryptographic keypair 406, which comprises public key 408 and private key 410. Public key 408 and private key 410 together can enable the creation of verifiable digital signatures. In some embodiments, cryptographic keypair 406 can be an elliptic curve cryptography (ECC) keypair. While cryptographic keypair 406 can conform to any suitable public key architecture (e.g., Rivest, Shamir, Adleman (RSA), . . . ), using ECC to sign and verify tokens offers several advantages compared to traditional RSA or other public-key algorithms

For example, ECC requires significantly smaller key sizes to achieve a comparable level of cryptographic strength. This reduction in key size leads to less overhead in storing, transmitting, and processing keys and signatures. In distributed systems or scenarios with limited bandwidth or tight latency requirements, smaller key sizes help improve performance and lower bandwidth costs.

As another example, ECC-based signatures (for example, ECDSA) tend to be shorter than RSA signatures of equivalent strength, meaning an ECC-signed token or certificate can be embedded in data payloads with less impact on overall message size. This shorter signature advantage becomes especially meaningful when tokens are included repeatedly, such as in a request header or within communications between clusters.

As still another example, ECC's computational efficiency can be a benefit in large-scale or resource-constrained environments. Many implementations report that ECC key-generation and signing operations can be faster than RSA at comparable security levels, particularly for short-lived or ephemeral certificates. This efficiency, combined with the smaller footprint, makes ECC a strong choice when tokens must be generated frequently or used in high-traffic cross-cluster authentication.

Regardless of the type of encryption being used (e.g., ECC, RSA, . . . ) when the cluster CA 104 signs the public key 408, CA 104 thus creates what is referred to herein as a “signing certificate” (e.g., signing certificate 414). Because the signing certificate can be chained to CA 104, any other cluster that trusts the CA certificate 404 can also trust tokens signed with the corresponding private key 410.

Once a user in cluster 102 authenticates locally (e.g., using a username and password or another local mechanism) cluster token service 402 creates a data payload describing the user, the cluster that issued the token, and an expiration time. The token service then signs that payload with private key 410, producing a cryptographically secure token. This token is passed back to the user (or client application), which can present it to remote clusters for verification. Those remote clusters validate the signature by looking up the public key 408, which is bound in the signing certificate, and confirming that the signing certificate chains correctly to CA 104, found in the local trust anchors. If the signature is valid and the token has not expired, the remote cluster accepts the token without needing to retrieve or replicate the user's original credentials.

Because CA 104, cluster CA certificate 404, and cryptographic keypair 406 remain under the control of cluster 102, cluster 102 can rotate its private key 410 or issue new signing certificates without requiring any additional exchange of secret information with other clusters. This design also avoids the performance and reliability issues encountered when clusters must repeatedly contact one another for credential verification. By maintaining its own CA 104, signing certificates, and token service 402 internally, cluster 102 ensures that users can be issued short-lived, portable tokens that are honored across a trusted federation of clusters, yet remain secure and verifiable through the authority embedded in cluster CA certificate 404.

Hence, as illustrated at reference numeral 412, cluster 102 can generate signing certificate 414. In more detail, as indicated at reference numeral 416, signing certificate 414 can be generated by signing public key 408 with cluster CA certificate 404. Thus, the signing certificate 414 can function as an officially recognized credential for the keypair 406 used by cluster token service 402, as the signing certificate 414 is to be trusted by other clusters in a federation. To accomplish this, the cluster's CA 104 (e.g., represented by cluster CA certificate 404) issues and signs the public key 408. Such effectively transforms the raw public key 408 into a signing certificate 414 that proves to third parties—specifically, other clusters that trust the CA certificate 404—that the holder of the corresponding private key 410 is legitimate and recognized by the cluster's authority.

In other words, by signing public key 408 with the cluster CA certificate 404, the cluster CA 104 vouches for that key, providing a clear chain of trust. Without this signature from the CA, the public key 408 may have no inherent trustworthiness when presented to a remote cluster. Once signed, signing certificate 414 ensures that remote clusters can verify tokens generated by private key 410 and be confident in their authenticity, provided they have imported or otherwise trust cluster CA certificate 404.

Thus, it can be readily appreciated that the disclosed subject matter can rely on two distinct pieces of cryptographic material to serve distinct purposes, namely, cluster CA certificate 404 and cryptographic keypair 406. By way of example, cluster CA certificate 404 can be an X.509 certificate that designates the cluster as its own mini certificate authority. This certificate can contain the cluster's CA public key, information identifying the cluster (e.g., including the cluster_id), and other metadata (e.g., validity dates). Cluster CA certificate 404 can be used to sign, and thereby vouch for, subordinate certificates, such as the signing certificate 414 that will later be used to sign ephemeral tokens 420. Other clusters will trust these subordinate certificates if they trust the cluster CA certificate 404.

On the other hand, cryptographic keypair 406, which can be generated using ECC as noted above, can comprise private key 410 (e.g., ec_priv_key) and public key 408 (ec_pub_key).

The ECC private key can be used to create digital signatures over ephemeral tokens 420, while the ECC public key can be embedded into signing certificate 414 (e.g., signed by the cluster CA certificate 404). Clusters 102 that trust a given CA 104 can then use the ECC public key (e.g., retrieved via the signing certificate) to verify those signatures.

In other words, the cluster CA certificate (e.g., CTS Signing CA) can be the “root of trust” for any given cluster, while the ECC keypair can be the actual keypair used to sign each short-lived token (e.g., ephemeral token 414). The cluster CA 104 signs (e.g., certifies) the ECC public key, thereby producing the signing certificate that other clusters 102 can trust since those other clusters 102 already trust the CA certificate.

In that regard, at reference numeral 418, cluster 102 can generate ephemeral token 420. Ephemeral token 420 can be a short-lived, signed credential that cluster token service 402 creates for a user (e.g., user 104A) who has been authenticated within the home cluster. Ephemeral token 420 can comprise two main components: the session data (e.g., also referred to herein as session token 424) and the digital signature. The session data typically includes the user's identity, the home cluster's identifier, a random token ID, and time-bound metadata such as an issue timestamp and an expiry timestamp. As illustrated at reference numeral 422, cluster 102 and/or cluster token service 402 can sign this session data using private key 410 associated with the signing certificate, producing a cryptographic signature that ensures the token's authenticity.

Because it is explicitly time-limited, ephemeral token 420 can offer a highly configurable balance between security and convenience. For example, in some embodiments ephemeral token 420 can remain valid only within the configured expiration window, reducing opportunities for misuse if intercepted. Once generated by cluster token service 402, this token can be issued to the user, as is illustrated in connection with reference numeral 426.

As illustrated at reference numeral 428, user 104 can then present ephemeral token 420 to other clusters within the federation for authentication. Each receiving cluster can verify the signature against the trusted copy of the issuing cluster's certificate authority. If the signature is valid and the token has not expired, the receiving cluster accepts it as proof of the user's identity. This mechanism enables cross-cluster authentication without sharing or replicating the user's actual credentials across multiple clusters.

Now referencing FIG. 5B, depicted is a schematic block diagram illustrating certain contents of an example session token 424 in accordance with certain embodiments of this disclosure. As noted, session token 424 (e.g., also referred to as session data) can represent the unsigned data portion of ephemeral token 420. Session token 424 can contain several key fields used to validate the user's identity and control the token's lifetime. For instance, signing certificate ID 502 can link the token to the specific signing certificate used for its eventual digital signature, enabling remote clusters to locate and verify public key 408 that authenticates the token. The cluster ID 504 can identify the home cluster that issued the token, allowing other clusters to recognize which authority vouches for the user

The temporary token ID 506 can serve as a random, uniquely generated identifier for this token instance, which can aid in preventing replay attacks, for example, and aid in maintaining a robust audit trail. The user ID 508 can denote the individual who was authenticated by the issuing cluster's local domain, establishing to remote clusters exactly who the token is meant to represent. The issue time 510 can mark when the token was created, while the expiry time 512 can specify when the token becomes invalid. Together, these time fields can ensure the token's validity period remains finite, limiting the risk if the token falls into unauthorized hands. This combination of fields, namely, the signing certificate ID, cluster ID, temporary token ID, user ID, issue time, and expiry time, can provide essential information for verifying the token's authenticity and ensuring it is used only within its designated operational window.

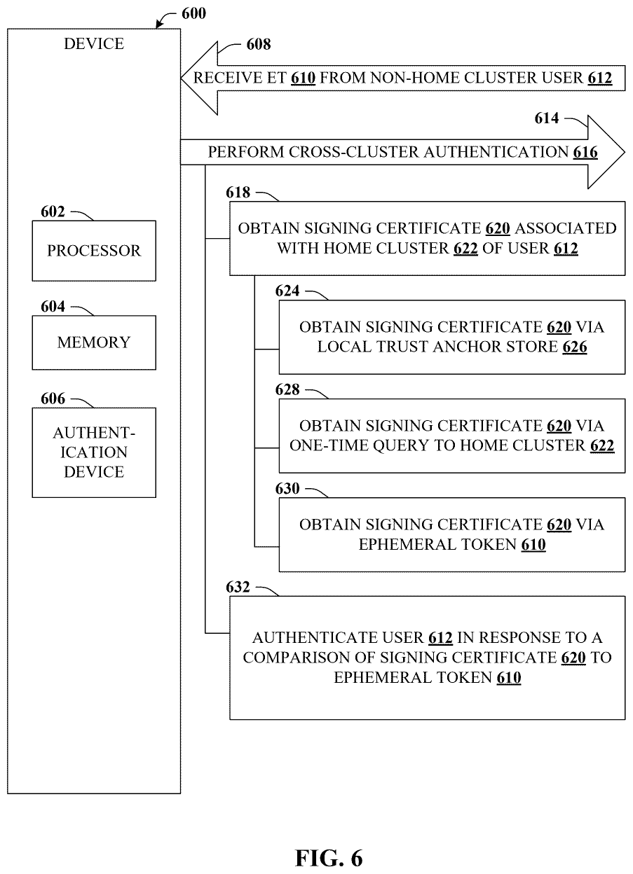

With reference now to FIG. 6, a schematic block diagram illustrating an example device 600 that can use an ephemeral token to provide cross-cluster authentication without relying on credential synchronization or access to the guest cluster in accordance with certain embodiments of this disclosure. In that regard, device 600 can, in some embodiments, be integrated into devices of a cluster such as cluster 102. For example, all or a portion of device 600 can be included in a certificate authority (e.g., CA 104) or a cluster token service (e.g., cluster token service 402).

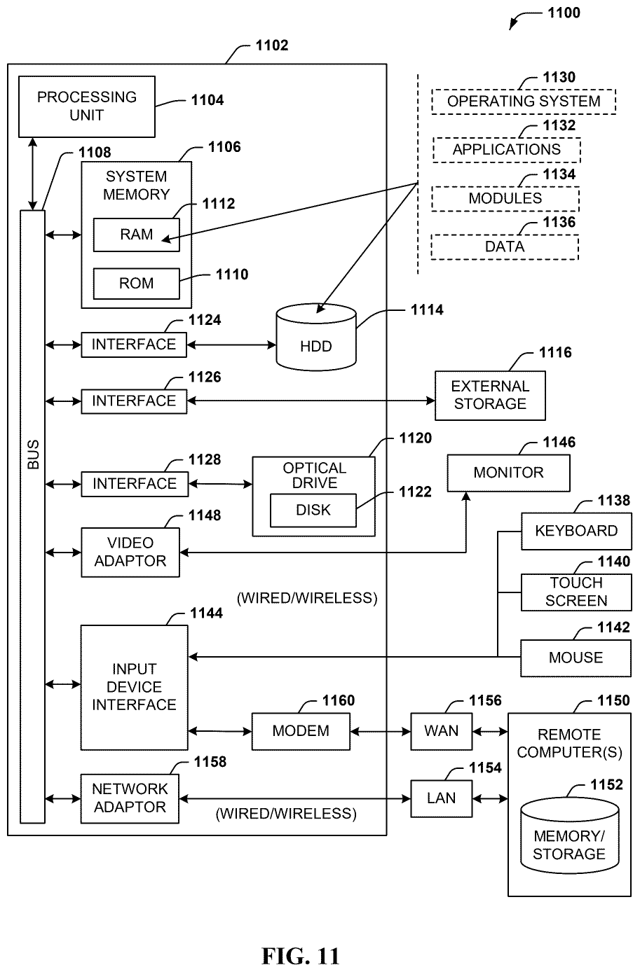

Device 600 can comprise at least one processor 602 that, potentially along with authentication device 606, can be specifically configured to perform functions associated with cross-cluster authentication. Device 600 can also comprise at least one memory 604 that stores executable instructions that, when executed by the at least one processor 602, can facilitate performance of operations. Processor(s) 602 can be a hardware processor having structural elements known to exist in connection with processing units or circuits, with various operations of processor 602 being represented by functional elements shown in the drawings herein that can require special-purpose instructions, for example, stored in memory 604 and/or authentication device 606. Along with these special-purpose instructions, processor 602 and/or authentication device 606 can be a special-purpose device. Further examples of the memory 604 and processor 602 can be found with reference to FIG. 11. It is to be appreciated that device 600 or computer 1102 can represent a server device or a client device of a storage or data service platform and computer 1102 can be used in connection with implementing one or more of the systems, devices, or components shown and described in connection with FIG. 6 and other figures disclosed herein.

As illustrated at reference numeral 608, device 600 can receive ephemeral token 610 (e.g., ephemeral token 420 of FIG. 4). Ephemeral token 610 can be received via user 612 as part of a request for cross-cluster authentication from user 612 having a different home cluster. An example of such is provided in connection with FIG. 1 in which user 106A, whose home cluster is cluster 102A, requests authentication to cluster 102B.

As illustrated at reference numeral 614, in response to receiving ephemeral token 610, device 600 can perform cross-cluster authentication 614. As part of cross-cluster authentication 614, as indicated at reference numeral 618, device 600 can obtain signing certificate 620 (e.g., signing certificate 414 of FIG. 4). As detailed, signing certificate 620 can be associated with home cluster 622 (e.g., cluster 102A of FIG. 1). Reference numeral 624, 628, and 630 are illustrative examples of various non-limiting ways of obtaining signing certificate 620. For example, as indicated at reference numeral 624, signing certificate 620 can be obtained by accessing a local trust anchor store 626. For instance, an administrator may have received or retrieved signing certificates 620 associated with other clusters to be part of the trust federation and stored the signing certificate 620 in the local trust anchor store 626.

In other embodiments or scenarios, in the event local trust anchor store 626 does not contain a copy of signing certificate 620, as indicated at reference numeral 628, signing certificate 620 can be obtained via a query or request to home cluster 622 (e.g., user 612's home cluster). It is noted that such need only be a one-time query and subsequently, signing certificate 620 can be stored to local trust anchor store 626. As such, this one-time query to facilitate authentication of user 612 can suffice for any subsequent request for the same or different user of that particular home cluster. In other words, apart from this one-time request, the disclosed techniques do not require active communication between clusters as part of the authentication process. In contrast, certain delegation techniques (e.g., detailed in connection with FIG. 2) rely on the available of the home cluster for each and every cross-cluster authentication request.

Further, in some embodiments, signing certificate 620 can be included in ephemeral token 610. Thus, the request for cross-cluster authentication itself can comprise signing certificate 620, as indicated at reference numeral 630. In this scenario, if signing certificate 620 for that particular home sector is not already in the local trust anchor store 626, signing certificate 620 can be extracted from ephemeral token 610 and added to local trust anchor store 626. As such, subsequent ephemeral tokens 610 would no longer need to include signing certificate 620. One advantage of including signing certificate 620 in ephemeral token 610 is that no direct communication is relied upon between the home cluster (e.g., cluster 102A) and the guest cluster (e.g., cluster 102B) at the time of authentication. Hence, the guest cluster can authenticate user 612 even during periods in which the home cluster is down or unavailable, which is not the case for certain delegation techniques. Regardless, providing cross-cluster authentication via a one-time communication with the home cluster in some embodiments, or by increasing the payload of the ephemeral token 610 to include signing certificate 620 can mitigate the need of certain other techniques for home cluster availability for cross-cluster authentication.

Regardless of the manner in which signing certificate 620 is obtained, at reference numeral 632, device 600 can authenticate user 612 in response to a comparison of certain information included in signing certificate 620 to certain information included in ephemeral token 610. In some embodiments, such can further include verifying that ephemeral token 610 has not expired, for example, by checking a issue time, expiry time or other field included in the ephemeral token 610 (e.g., a signed version of session token 424).

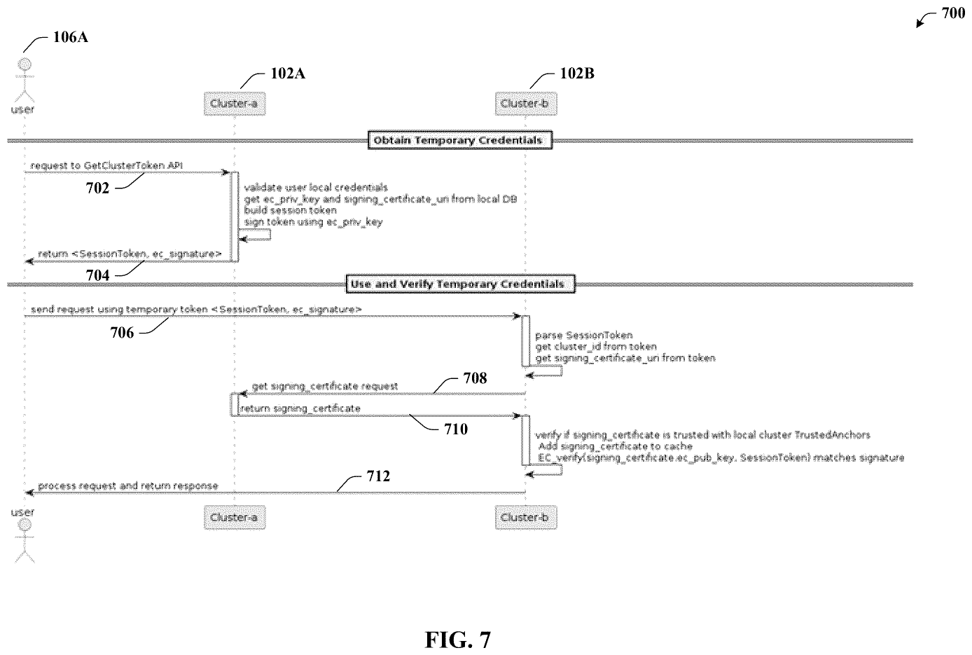

Turning now to FIG. 7, a call flow diagram 700 is presented illustrating certain sequences of events or interactions relating to creation or use of an ephemeral token for cross-cluster authentication in accordance with certain embodiments of this disclosure.

Initially, as indicated at reference numeral 702, user 106A send a request to cluster 102A. For example, the request can be provided via a GetClusterToken application programming interface (API) as part of cluster token service 402, for example. Cluster 102A can then proceed to validate local credentials of user 106A, get private key 410 (e.g., ec_priv_key) and signing certificate 414 from a local data store or another source, then build session token 424. By signing session token 424 with private key 410, ephemeral token 420 can be constructed and returned to user 106A, as indicated at reference numeral 704. Thus, user 106A is able to obtain (e.g., via a cluster token service 402 for example) ephemeral token 420 at his or her home cluster (e.g., cluster 102A). As detailed herein, the ephemeral token 420 can then be used for cross-cluster authentication such as allowing authentication at a different cluster such as cluster 102B.

In that regard, at reference numeral 706, user 106A can send a request that comprises ephemeral token 420 to cluster 102B. Cluster 102B can then parse session token 424A to retrieve a cluster ID of the home cluster (e.g., cluster 102A) and then retrieve the associate signing certificate 414. If the signing certificate 414 is not in local trust anchor store 626 or not included in the ephemeral token 420, then such can be retrieved from the home cluster, for instance, via a one-time request-response illustrated at reference numerals 708 and 710. Thus, acquisition of the appropriate signing certificate 414 is only minimally (or in some embodiments not at all) reliant on the availability of cluster 102A to cluster 102B.

Upon acquisition of signing certificate 414, cluster 102B can verify whether signing certificate 414 is trusted with local trust anchors, add, if not already present, signing certificate 414 to local trust anchor store 626, and verify that public key 408 matches that of signing certificate 414. In some embodiments, other checks or verifications can occur such as checking for expiration or the like. Thereafter, upon satisfaction, as indicated at reference numeral 712, a response can be provided to user 106A.

### Example Methods

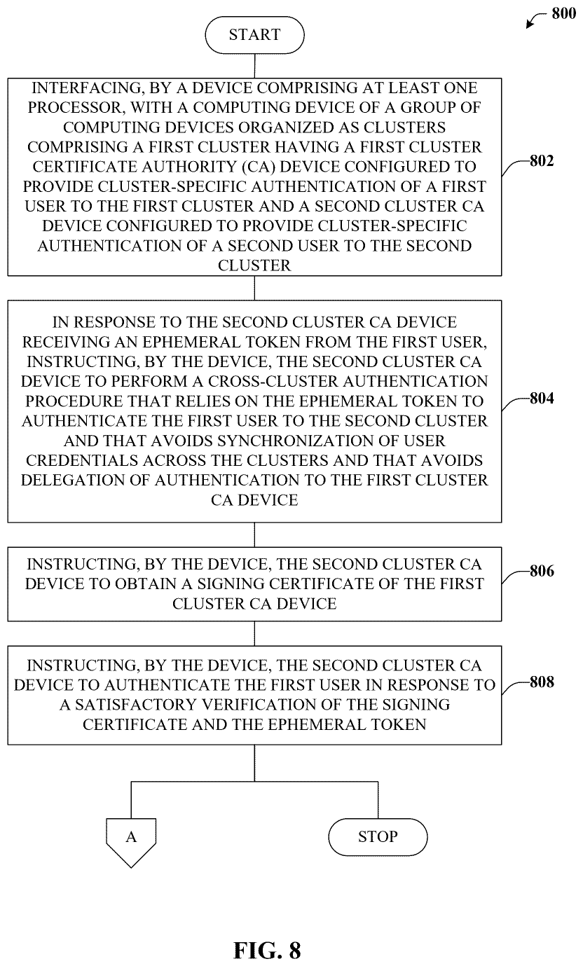

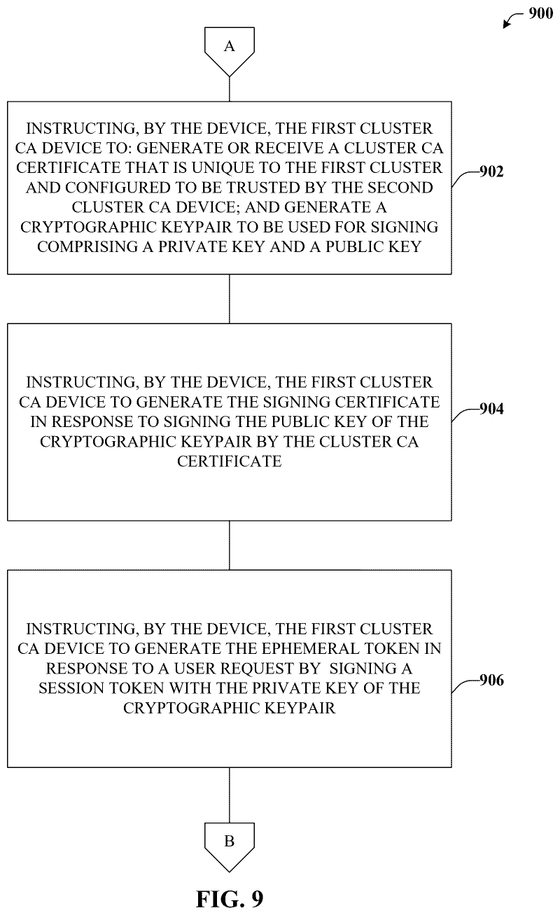

FIGS. 8 and 9 illustrate various methods in accordance with the disclosed subject matter. While, for purposes of simplicity of explanation, the methods are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a method could alternatively be represented as a series of interrelated states or events, such as in a state diagram. Moreover, not all illustrated acts may be required to implement a method in accordance with the disclosed subject matter. Additionally, it should be further appreciated that the methods disclosed hereinafter and throughout this specification are capable of being stored on an article of manufacture to facilitate transporting and transferring such methods to computers.

Referring now to FIG. 8, exemplary method 800 is depicted. Method 800 can use an ephemeral token to provide cross-cluster authentication without relying on credential synchronization or access to the guest cluster in accordance with certain embodiments of this disclosure. While method 800 describes a complete method, in some embodiments, method 800 can include one or more elements of method 900, as illustrated by insert A.

At reference numeral 802, a device comprising at least one processor can interface with a group of computing devices organized as clusters comprising a first cluster having a first cluster certificate authority (CA) device configured to provide cluster-specific authentication of a first user to the first cluster and a second cluster CA device configured to provide cluster-specific authentication of a second user to the second cluster.

At reference numeral 804, in response to the second cluster CA device receiving an ephemeral token from the first user, the device can instruct the second cluster CA device to perform a cross-cluster authentication procedure. The cross-cluster authentication procedure can rely on the ephemeral token to authenticate the first user to the second cluster. Thus, the cross-cluster authentication procedure can operate without relying on synchronization of user credentials across the clusters or without relying on delegation of authentication to the first cluster CA device. The cross-cluster authentication procedure can comprise all or a portion of elements detailed in connection with reference numeral 806 and 808.

At reference numeral 806, the device can instruct the second cluster CA device to obtain a signing certificate of the first cluster CA device. For example, in some embodiments, the signing certificate can be obtained from a local trust anchor store. In some embodiments, the signing certificate can be obtained from by a request (e.g., one-time request) to the home cluster indicated by the ephemeral token and thereafter added to the local trust anchor store. In still other embodiments, the signing certificate can be included in the ephemeral token and extracted there from. At reference numeral 808, the device can instruct the second cluster CA device to authenticate the first user in response to a satisfactory comparison of the signing certificate and the ephemeral token. Method 800 can terminate in some embodiments, or proceed to insert A in other embodiments, which is further detailed in connection with FIG. 9

Turning now to FIG. 9, exemplary method 900 is depicted. Method 900 can provide additional aspects or elements relating to using an ephemeral token to provide cross-cluster authentication without relying on credential synchronization or access to the guest cluster in accordance with certain embodiments of this disclosure.

At reference numeral 902, the device introduced at reference numeral 802 comprising at least one processor can instruct the first cluster CA device to generate or receive a cluster CA certificate that is unique to the first cluster and configured to be trusted by the second cluster CA device. Additionally, the device can instruct the first CA device to generate a cryptographic keypair comprising a private key and a public key.

At reference numeral 904, the device can instruct the first cluster CA device to generate the signing certificate in response to signing the public key of the cryptographic keypair with the cluster CA certificate.

At reference numeral 906, the device can instruct the first cluster CA device to generate the ephemeral token in response to signing a session token with the private key of the cryptographic keypair.

### Example Operating Environments

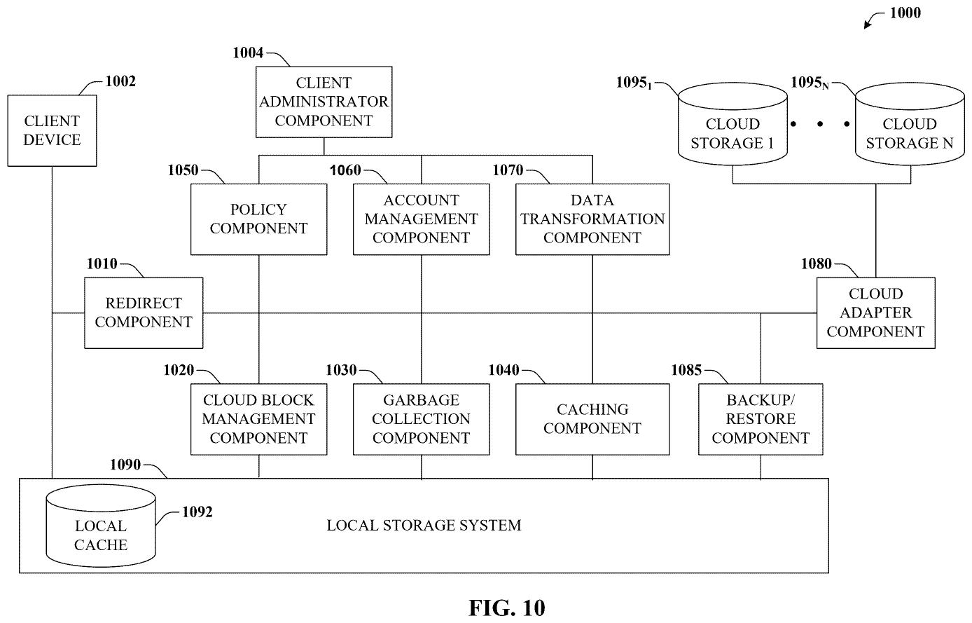

To provide further context for various aspects of the subject specification, FIGS. 10 and 11 illustrate, respectively, a block diagram of an example distributed file storage system 1000 that employs tiered cloud storage and block diagram of a computer 1102 operable to execute the disclosed storage architecture in accordance with aspects described herein.

Referring now to FIG. 10, there is illustrated an example local storage system including cloud tiering components and a cloud storage location in accordance with implementations of this disclosure. Client device 1002 can access local storage system 1090. Local storage system 1090 can be a node and cluster storage system such as an EMC Isilon Cluster that operates under OneFS operating system. Local storage system 1090 can also store the local cache 1092 for access by other components. It can be appreciated that the systems and methods described herein can run in tandem with other local storage systems as well.

As more fully described below with respect to redirect component 1010, redirect component 1010 can intercept operations directed to stub files. Cloud block management component 1020, garbage collection component 1030, and caching component 1040 may also be in communication with local storage system 1090 directly as depicted in FIG. 10 or through redirect component 1010. A client administrator component 1004 may use an interface to access the policy component 1050 and the account management component 1060 for operations as more fully described below with respect to these components. Data transformation component 1070 can operate to provide encryption and compression to files tiered to cloud storage. Cloud adapter component 1080 can be in communication with cloud storage 1 1095₁ and cloud storage N 1095_{N}, where N is a positive integer. It can be appreciated that multiple cloud storage locations can be used for storage including multiple accounts within a single cloud storage location as more fully described in implementations of this disclosure. Further, a backup/restore component 1085 can be utilized to back up the files stored within the local storage system 1090.

Cloud block management component 1020 manages the mapping between stub files and cloud objects, the allocation of cloud objects for stubbing, and locating cloud objects for recall and/or reads and writes. It can be appreciated that as file content data is moved to cloud storage, metadata relating to the file, for example, the complete inode and extended attributes of the file, still are stored locally, as a stub. In one implementation, metadata relating to the file can also be stored in cloud storage for use, for example, in a disaster recovery scenario.

Mapping between a stub file and a set of cloud objects models the link between a local file (e.g., a file location, offset, range, etc.) and a set of cloud objects where individual cloud objects can be defined by at least an account, a container, and an object identifier. The mapping information (e.g., mapinfo) can be stored as an extended attribute directly in the file. It can be appreciated that in some operating system environments, the extended attribute field can have size limitations. For example, in one implementation, the extended attribute for a file is 8 kilobytes. In one implementation, when the mapping information grows larger than the extended attribute field provides, overflow mapping information can be stored in a separate system b-tree. For example, when a stub file is modified in different parts of the file, and the changes are written back in different times, the mapping associated with the file may grow. It can be appreciated that having to reference a set of non-sequential cloud objects that have individual mapping information rather than referencing a set of sequential cloud objects, can increase the size of the mapping information stored. In one implementation, the use of the overflow system b-tree can limit the use of the overflow to large stub files that are modified in different regions of the file.

File content can be mapped by the cloud block management component 1020 in chunks of data. A uniform chunk size can be selected where all files that are tiered to cloud storage can be broken down into chunks and stored as individual cloud objects per chunk. It can be appreciated that a large chunk size can reduce the number of objects used to represent a file in cloud storage; however, a large chunk size can decrease the performance of random writes.

The account management component 1060 manages the information for cloud storage accounts. Account information can be populated manually via a user interface provided to a user or administrator of the system. Each account can be associated with account details such as an account name, a cloud storage provider, a uniform resource locator (“URL”), an access key, a creation date, statistics associated with usage of the account, an account capacity, and an amount of available capacity. Statistics associated with usage of the account can be updated by the cloud block management component 1020 based on list of mappings it manages. For example, each stub can be associated with an account, and the cloud block management component 1020 can aggregate information from a set of stubs associated with the same account. Other example statistics that can be maintained include the number of recalls, the number of writes, the number of modifications, and the largest recall by read and write operations, etc. In one implementation, multiple accounts can exist for a single cloud service provider, each with unique account names and access codes.

The cloud adapter component 1080 manages the sending and receiving of data to and from the cloud service providers. The cloud adapter component 1080 can utilize a set of APIs. For example, each cloud service provider may have provider specific API to interact with the provider.

A policy component 1050 enables a set of policies that aid a user of the system to identify files eligible for being tiered to cloud storage. A policy can use criteria such as file name, file path, file size, file attributes including user generated file attributes, last modified time, last access time, last status change, and file ownership. It can be appreciated that other file attributes not given as examples can be used to establish tiering policies, including custom attributes specifically designed for such purpose. In one implementation, a policy can be established based on a file being greater than a file size threshold and the last access time being greater than a time threshold.

In one implementation, a policy can specify the following criteria: stubbing criteria, cloud account priorities, encryption options, compression options, caching and IO access pattern recognition, and retention settings. For example, user selected retention policies can be honored by garbage collection component 1030. In another example, caching policies such as those that direct the amount of data cached for a stub (e.g., full vs. partial cache), a cache expiration period (e.g., a time period where after expiration, data in the cache is no longer valid), a write back settle time (e.g., a time period of delay for further operations on a cache region to guarantee any previous writebacks to cloud storage have settled prior to modifying data in the local cache), a delayed invalidation period (e.g., a time period specifying a delay until a cached region is invalidated thus retaining data for backup or emergency retention), a garbage collection retention period, backup retention periods including short term and long term retention periods, etc.

A garbage collection component 1030 can be used to determine which files/objects/data constructs remaining in both local storage and cloud storage can be deleted. In one implementation, the resources to be managed for garbage collection include CMOs, cloud data objects (CDOs) (e.g., a cloud object containing the actual tiered content data), local cache data, and cache state information.

A caching component 1040 can be used to facilitate efficient caching of data to help reduce the bandwidth cost of repeated reads and writes to the same portion (e.g., chunk or sub-chunk) of a stubbed file, can increase the performance of the write operation, and can increase performance of read operations to portion of a stubbed file accessed repeatedly. As stated above with regards to the cloud block management component 1020, files that are tiered are split into chunks and in some implementations, sub chunks. Thus, a stub file or a secondary data structure can be maintained to store states of each chunk or sub-chunk of a stubbed file. States (e.g., stored in the stub as cacheinfo) can include a cached data state meaning that an exact copy of the data in cloud storage is stored in local cache storage, a non-cached state meaning that the data for a chunk or over a range of chunks and/or sub chunks is not cached and therefore the data has to be obtained from the cloud storage provider, a modified state or dirty state meaning that the data in the range has been modified, but the modified data has not yet been synched to cloud storage, a sync-in-progress state that indicates that the dirty data within the cache is in the process of being synced back to the cloud and a truncated state meaning that the data in the range has been explicitly truncated by a user. In one implementation, a fully cached state can be flagged in the stub associated with the file signifying that all data associated with the stub is present in local storage. This flag can occur outside the cache tracking tree in the stub file (e.g., stored in the stub file as cacheinfo), and can allow, in one example, reads to be directly served locally without looking to the cache tracking tree.

The caching component 1040 can be used to perform at least the following seven operations: cache initialization, cache destruction, removing cached data, adding existing file information to the cache, adding new file information to the cache, reading information from the cache, updating existing file information to the cache, and truncating the cache due to a file operation. It can be appreciated that besides the initialization and destruction of the cache, the remaining five operations can be represented by four basic file system operations: Fill, Write, Clear and Sync. For example, removing cached data is represented by clear, adding existing file information to the cache by fill, adding new information to the cache by write, reading information from the cache by read following a fill, updating existing file information to the cache by fill followed by a write, and truncating cache due to file operation by sync and then a partial clear.

In one implementation, the caching component 1040 can track any operations performed on the cache. For example, any operation touching the cache can be added to a queue prior to the corresponding operation being performed on the cache. For example, before a fill operation, an entry is placed on an invalidate queue as the file and/or regions of the file will be transitioning from an uncached state to cached state. In another example, before a write operation, an entry is placed on a synchronization list as the file and/or regions of the file will be transitioning from cached to cached-dirty. A flag can be associated with the file and/or regions of the file to show that it has been placed in a queue and the flag can be cleared upon successfully completing the queue process.

In one implementation, a time stamp can be utilized for an operation along with a custom settle time depending on the operations. The settle time can instruct the system how long to wait before allowing a second operation on a file and/or file region. For example, if the file is written to cache and a write back entry is also received, by using settle times, the write back can be re-queued rather than processed if the operation is attempted to be performed prior to the expiration of the settle time.

In one implementation, a cache tracking file can be generated and associated with a stub file at the time it is tiered to the cloud. The cache tracking file can track locks on the entire file and/or regions of the file and the cache state of regions of the file. In one implementation, the cache tracking file is stored in an Alternate Data Stream (“ADS”). It can be appreciated that ADS are based on the New Technology File System (“NTFS”) ADS. In one implementation, the cache tracking tree tracks file regions of the stub file, cached states associated with regions of the stub file, a set of cache flags, a version, a file size, a region size, a data offset, a last region, and a range map.

In one implementation, a cache fill operation can be processed by the following steps: (1) an exclusive lock on can be activated on the cache tracking tree; (2) it can be verified whether the regions to be filled are dirty; (3) the exclusive lock on the cache tracking tree can be downgraded to a shared lock; (4) a shared lock can be activated for the cache region; (5) data can be read from the cloud into the cache region; (6) update the cache state for the cache region to cached; and (7) locks can be released.

In one implementation, a cache read operation can be processed by the following steps: (1) a shared lock on the cache tracking tree can be activated; (2) a shared lock on the cache region for the read can be activated; (3) the cache tracking tree can be used to verify that the cache state for the cache region is not “not cached;” (4) data can be read from the cache region; (5) the shared lock on the cache region can be deactivated; (6) the shared lock on the cache tracking tree can be deactivated.

In one implementation, a cache write operation can be processed by the following steps: (1) an exclusive lock on can be activated on the cache tracking tree; (2) the file can be added to the synch queue; (3) if the file size of the write is greater than the current file size, the cache range for the file can be extended; (4) the exclusive lock on the cache tracking tree can be downgraded to a shared lock; (5) an exclusive lock can be activated on the cache region; (6) if the cache tracking tree marks the cache region as “not cached” the region can be filled; (7) the cache tracking tree can updated to mark the cache region as dirty; (8) the data can be written to the cache region; (9) the lock can be deactivated.

In one implementation, data can be cached at the time of a first read. For example, if the state associated with the data range called for in a read operation is non-cached, then this would be deemed a first read, and the data can be retrieved from the cloud storage provider and stored into local cache. In one implementation, a policy can be established for populating the cache with range of data based on how frequently the data range is read; thus, increasing the likelihood that a read request will be associated with a data range in a cached data state. It can be appreciated that limits on the size of the cache, and the amount of data in the cache can be limiting factors in the amount of data populated in the cache via policy.

A data transformation component 1070 can encrypt and/or compress data that is tiered to cloud storage. In relation to encryption, it can be appreciated that when data is stored in off-premises cloud storage and/or public cloud storage, users can require data encryption to ensure data is not disclosed to an illegitimate third party. In one implementation, data can be encrypted locally before storing/writing the data to cloud storage.

In one implementation, the backup/restore component 1085 can transfer a copy of the files within the local storage system 1090 to another cluster (e.g., target cluster). Further, the backup/restore component 1085 can manage synchronization between the local storage system 1090 and the other cluster, such that, the other cluster is timely updated with new and/or modified content within the local storage system 1090.

In order to provide additional context for various embodiments described herein, FIG. 11 and the following discussion are intended to provide a brief, general description of a suitable computing environment 1100 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments of the aspects described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1194 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 1102.11 (a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 5 GHz radio band at a 54 Mbps (802.11a) data rate, and/or a 2.4 GHz radio band at an 11 Mbps (802.11b), a 54 Mbps (802.11g) data rate, or up to a 600 Mbps (802.11 n) data rate for example, or with products that contain both bands (dual band), so the networks can provide real-world performance similar to the basic “10BaseT” wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. In an aspect, when a processor executes instructions to perform “operations”, this could include the processor performing the operations directly and/or facilitating, directing, or cooperating with another device or component to perform the operations.

In the subject specification, terms such as “data store,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated aspects of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or API components.

Further, the various embodiments can be implemented as a method, apparatus, or article of manufacture using standard programming and/or engineering techniques to produce software, firmware, hardware, or any combination thereof to control a computer to implement one or more aspects of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips. . . ), optical disks (e.g., compact disk (CD), digital versatile disk (DVD). . . ), smart cards, and flash memory devices (e.g., card, stick, key drive. . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
operating within a group of computing devices organized as clusters comprising a first cluster having a first cluster certificate authority (CA) device configured to provide cluster-specific authentication of a first user to the first cluster and a second cluster CA device configured to provide cluster-specific authentication of a second user to the second cluster;
in response to the second cluster CA device receiving an ephemeral token from the first user, performing a cross-cluster authentication procedure that relies on the ephemeral token to authenticate the first user to the second cluster rather than relying on synchronization of user credentials across the clusters or delegating authentication to the first cluster CA device, the cross-cluster authentication procedure comprising:
obtaining, by the second cluster CA device, a signing certificate of the first cluster CA device, and
authenticating the first user in response to a satisfactory verification of the signing certificate and the ephemeral token.

2. The system of claim 1, wherein the ephemeral token is generated by the first cluster CA device and communicated to the first user to enable the first user to be authenticated by another cluster of the clusters.

3. The system of claim 1, wherein the ephemeral token is generated in response to interaction with a cluster token service offered by at least one of the clusters.

4. The system of claim 1, wherein the operations further comprise:
associating the first cluster with a cluster identifier;
generating or receiving, by the first cluster CA device, a cluster CA certificate that is unique to the first cluster and configured to be trusted by other clusters of the clusters;
generating, by the first cluster CA device, a cryptographic keypair comprising a private key and a public key.

5. The system of claim 4, wherein the operations further comprise generating the signing certificate in response to signing the public key of the cryptographic keypair with the cluster CA certificate.

6. The system of claim 4, wherein the operations further comprise generating the ephemeral token by signing a session token with the private key of the cryptographic keypair.

7. The system of claim 6, wherein the session token comprises at least one of:
a signing certificate identifier comprising a uniform resource identifier (URI), or other identifier, indicative of the signing certificate used by the first cluster or any issuing cluster,
the cluster identifier that uniquely identifies any member of the clusters,
a temporary token identifier that identifies a temporary token,
a user identifier that identifies the first user as being authenticated by the first cluster CA device,
an issue time indicative of when the session token was created, or
an expiry time indicative of when the session token is no longer valid.

8. The system of claim 4, wherein the signing certificate, representing the public key of the cryptographic keypair that was signed by the cluster CA certificate, is configured to authenticate the public key as having been issued by the first cluster CA device.

9. The system of claim 4, wherein the ephemeral token, representing the session token that was signed by the private key, is configured to authenticate the private key as having been issued by the first cluster CA device and, by proxy, that the ephemeral token was issued by the first cluster CA device.

10. The system of claim 1, wherein the signing certificate that is obtained by the second cluster CA device is obtained from a local trust anchor store.

11. The system of claim 1, wherein the signing certificate, which is obtained by the second cluster CA device, is obtained from a one-time query to the first cluster CA device and thereafter stored to a local trust anchor store.

12. The system of claim 1, wherein the signing certificate is included in the ephemeral token that is received from the first user.

13. A system, comprising:
at least one processor; and
at least one memory that stores executable instructions that, when executed by the at least one processor, facilitate performance of operations, comprising:
associating a first cluster with a cluster identifier, wherein a group of computing devices is organized as clusters, the clusters comprising:
the first cluster having a first cluster certificate authority (CA) device configured to provide cluster-specific authentication of a first user to the first cluster, and
a second cluster CA device configured to provide cluster-specific authentication of a second user to the second cluster;
generating, via the first cluster CA device, a cluster CA certificate that is unique to the first cluster based on the cluster identifier and configured to be trusted by the second cluster;
generating, via the first cluster CA device, an elliptical curve cryptography (ECC) keypair comprising an ECC private key and an ECC public key;
generating, via the first cluster CA device, a signing certificate in response to signing the ECC public key with the cluster CA certificate and making the signing certificate available to the second cluster CA device;
generating, via the first cluster CA device, an ephemeral token in response to signing a session token with the ECC private key and providing the ephemeral token to the first user; and
in response to the second cluster CA device receiving the ephemeral token from the first user, performing a cross-cluster authentication procedure comprising:
obtaining, via the second cluster CA device, the signing certificate, and
authenticating the first user in response to a satisfactory verification of the signing certificate and the ephemeral token.

14. The system of claim 13, wherein the ephemeral token is generated in response to interaction with a cluster token service offered via at least one of the clusters.

15. The system of claim 13, wherein the ephemeral token comprises the signing certificate, or the second cluster CA device performs a one-time interface with the first CA cluster device to obtain the signing certificate in response to receipt of the ephemeral token.

16. The system of claim 13, wherein the operations further comprise, in response to the second cluster CA device initially receiving the signing certificate, storing, by the second CA cluster device at least a portion of the signing certificate to a local trust anchor store.

17. A method, comprising:
interfacing, by a device comprising at least one processor, with a computing device of a group of computing devices organized as clusters comprising a first cluster having a first cluster certificate authority (CA) device configured to provide cluster-specific authentication of a first user to the first cluster and a second cluster CA device configured to provide cluster-specific authentication of a second user to the second cluster;
in response to the second cluster CA device receiving an ephemeral token from the first user, instructing, by the device, the second cluster CA device to perform a cross-cluster authentication procedure that relies on the ephemeral token to authenticate the first user to the second cluster and that avoids synchronization of user credentials across the clusters and that avoids delegation of authentication to the first cluster CA device, the cross-cluster authentication procedure comprising;
instructing, by the device, the second cluster CA device to obtain a signing certificate of the first cluster CA device; and
instructing, by the device, the second cluster CA device to authenticate the first user in response to a satisfactory verfication of the signing certificate and the ephemeral token.

18. The method of claim 17, further comprising, instructing, by the device, the first cluster CA device to:
generate or receive a cluster CA certificate that is unique to the first cluster and configured to be trusted by the second cluster CA device; and
generate a cryptographic keypair to be used for signing purposes comprising a private key and a public key.

19. The method of claim 18, further comprising instructing, by the device, the first cluster CA device to generate the signing certificate in response to signing the public key of the cryptographic keypair by the cluster CA certificate.

20. The method of claim 18, further comprising instructing, by the device, the first cluster CA device to generate the ephemeral token in response to a user request by signing a session token with the private key of the cryptographic keypair.
